(19) United States
(12) Patent Application Publication
(10) Pub. No.: US 2019/0170567 A1
(43) Pub. Date: Jun. 6, 2019

(54) METHODS AND APPARATUS TO DETECT LOAD APPLIED TO A VEHICLE SUSPENSION

(71) Applicant: Ford Global Technologies, LLC, Dearborn, MI (US)

(72) Inventors: Elliott Pearson, Shelby Township, MI (US); Anton Rogness, Dearborn, MI (US); Andrew Niedert, Farmington Hills, MI (US)

(21) Appl. No.: 15/829,523

(22) Filed: Dec. 1, 2017

(51) Int. Cl. G01G 19/12; B60G 17/018; G01L 1/22

(52) U.S. Cl. CPC G01G 19/12; B60G 17/0182; B60G 2400/60; B60G 2401/11; G01L 1/2287

(57) ABSTRACT

Methods, apparatus, systems and articles of manufacture are disclosed to detect load applied to a vehicle suspension. An example apparatus includes a vehicle spring positioned between a first spring seat and a second spring seat. A cap is coupled to the first spring seat to define a cavity. A force sensor is positioned in the cavity adjacent a surface of the first spring seat.

### FIELD OF THE DISCLOSURE

This disclosure relates generally to detecting vehicle weight and, more particularly, to methods and apparatus to detect load applied to a vehicle suspension.

### BACKGROUND

In recent years, determining a weight of a vehicle has become increasingly sophisticated. For example, some systems determine a weight of a vehicle based on a measured pressure applied to a suspension. In some examples, vehicle suspension systems include load sensing devices that measure pressure.

### SUMMARY

An example apparatus includes a vehicle spring positioned between a first spring seat and a second spring seat. A cap is coupled to the first spring seat to define a cavity. A force sensor is positioned in the cavity adjacent a surface of the first spring seat.

An example apparatus including a spring seat, means for biasing, and a force sensor positioned between the spring seat and the means for biasing.

An example apparatus including means for biasing positioned between a first spring seat and a second spring seat. A cap coupled to the first spring seat to define a cavity. An isolator positioned in the cavity. The example apparatus also includes means for sensing a force positioned in the cavity adjacent a surface of the first spring seat.

### BRIEF DESCRIPTION OF THE DRAWINGS

FIG. 1 illustrates an example vehicle in which the teachings of this disclosure may be implemented.

FIG. 2 illustrates an example suspension constructed in accordance with the teachings of this disclosure that may be used to implement the example vehicle of FIG. 1.

FIG. 3 is a partially exploded view of the example suspension of FIG. 2.

FIGS. 4A and 4B illustrate an example sensor of the example suspension of FIGS. 2 and 3.

FIG. 5 illustrates another example suspension that may be used to implement the example vehicle of FIG. 1.

FIG. 6 is a partially exploded view of the example suspension of FIG. 5.

FIGS. 7A and 7B illustrate an example sensor of the example suspension of FIGS. 5 and 6.

FIG. 8 is an example method for positioning a sensor on the example vehicle suspension of FIGS. 2 and 3.

FIG. 9 is an example method for positioning a sensor on the example vehicle suspension of FIGS. 5 and 6.

The figures are not to scale. Wherever possible, the same reference numbers will be used throughout the drawing(s) and accompanying written description to refer to the same or like parts.

### DETAILED DESCRIPTION

Some known vehicles employ measuring apparatus to detect or measure a vehicle weight. Some known example vehicles employ sensors that are integrated with a vehicle suspension. Integrating a sensor with a suspension system is beneficial because a total weight of the vehicle is sensed through the suspension.

Some known vehicle suspensions employ measuring apparatus that measure a pressure applied to an airbag suspension system to determine vehicle weight. Some known vehicle suspension systems include loading apparatus that bend or deflect (e.g., relative to a flat or initial position) to measure a bending force to detect or measure vehicle weight. As a result of the size and/or packaging constraints of such loading apparatus, in some instances, significant modification of preexisting suspension geometries may be needed to avoid changing (e.g., raising) a vehicle ride height and/or handling characteristic of a vehicle. In some cases, modifications necessary to implement such loading apparatus can double the number of suspension components, increasing manufacturing costs.

Examples disclosed herein provide an efficient, low-profile solution to determine vehicle weight across multiple platforms without the need to design different suspension architectures. Example suspensions disclosed herein employ a force sensor (e.g., a thin-film transducer) to sense an applied force to the vehicle suspensions. For example, when a load is applied to the suspensions, example sensors disclosed herein produce an electrical signal (e.g., a voltage, a change in resistance, a change in capacitance, etc.) based on amount of force or pressure applied to the suspensions and/or the sensors. Some example sensors disclosed herein may be formed from Quantum Tunneling Composites (e.g., composite materials of metals, non-conducting elastomeric binders, etc.) that allow for the production of thin sensors.

Additionally, example sensors disclosed herein may have different configurations to accommodate different types of vehicle suspensions (e.g., a MacPherson strut, a leaf spring suspension, etc.). For example, example sensors disclosed herein may have a rectangular shape, a circular shape, and/or any other shape. In some instances, a shape or profile of an example sensor disclosed herein may improve sensing accuracy.

Some example sensors disclosed herein may be isolated between a first side by a spring seat (e.g., that provides natural resistance to shock and environmental conditions) and a second side of the spring seat by a rubber isolator. Isolation of the sensor enables the sensor to more accurately sense a weight of a vehicle. As such, the example sensors disclosed herein improve electronic stability control, accuracy in driveline calibration, algorithms based on vehicle weight distribution, autonomous vehicle systems, and information provided to a driver to reduce unbalanced driving. Some example sensors disclosed herein may be printed or formed directly onto a spring seat or an upper strut surface of a suspension. For example, sensors disclosed herein may be printed onto the spring seat using heat molding manufacturing processes or techniques. Printing an example sensor directly onto a suspension component reduces part count.

The teachings of this disclosure may be implemented with any type of suspension (e.g., a steerable suspension, a non-steerable suspension, a MacPherson strut, a Short Long Arms suspension) for use with any types of vehicles.

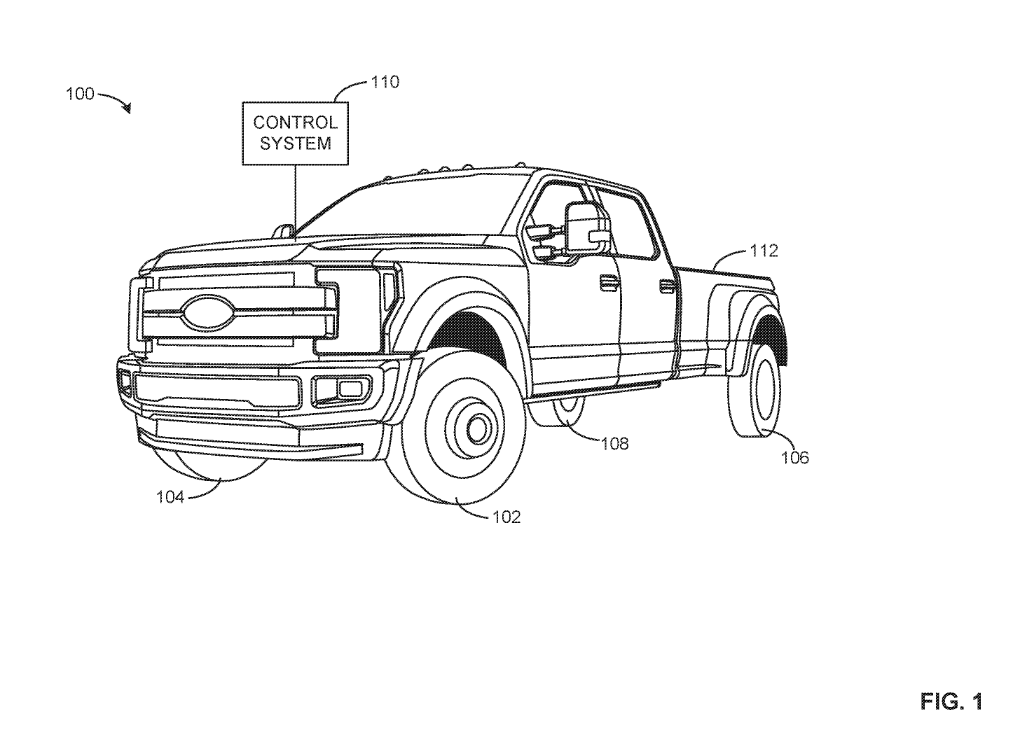

FIG. 1 illustrates an example vehicle 100 in which the teachings of this disclosure may be implemented. In the illustrated example, the vehicle 100 includes front wheels 102, 104 supported by a front suspension and rear wheels 106, 108 supported by a rear suspension. The vehicle 100 (e.g., the front and rear suspensions) of the illustrated example includes a control system 110 to measure total vehicle weight information to improve ride and/or handling characteristics. For example, the control system 110 may determine an uneven load in a bed 112 of the vehicle 100.

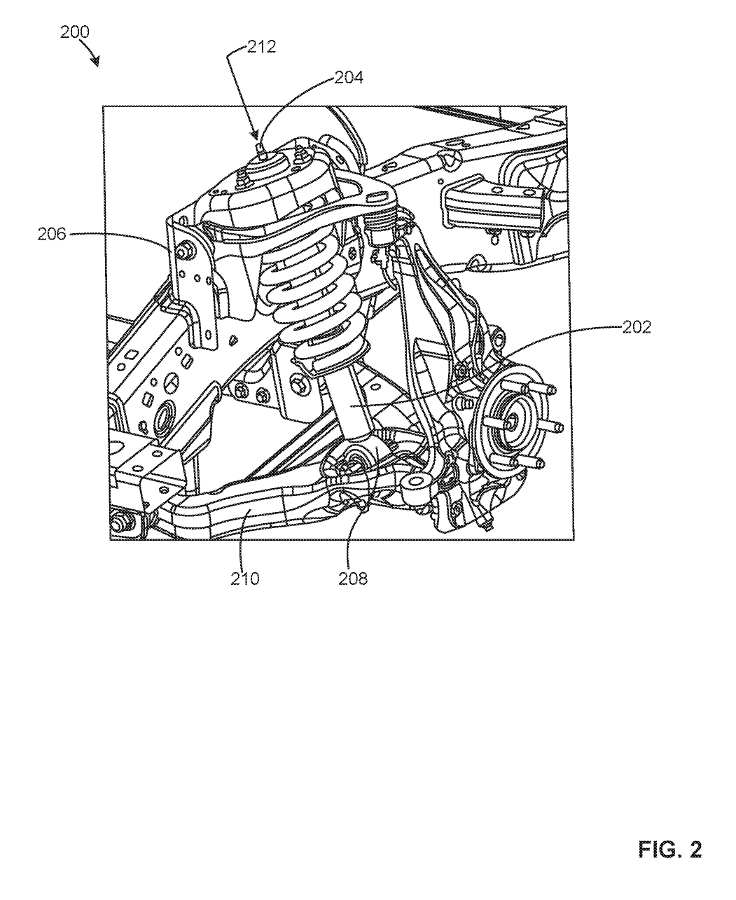

FIG. 2 illustrates an example suspension 200 of the vehicle 100 of FIG. 1. For example, the suspension 200 of the illustrated example may support the front driver-side wheel 102 (FIG. 1). The front passenger-side wheel 104 may be supported by a similar (e.g., identical) suspension (FIG. 1).

The suspension 200 of the illustrated example is an example coil-spring suspension (e.g., a MacPherson strut). The suspension 200 of the illustrated example includes a shock absorber 202. The shock absorber 202 includes a first end 204 (e.g., a piston end) coupled to a frame 206 of the vehicle 100 adjacent the wheel 102 and a second end 208 (e.g., a housing) coupled to a suspension control link 210 of the suspension 200.

During operation, the suspension 200 (e.g., the shock absorber 202) of the illustrated example controls unwanted motion of the vehicle 100 by reducing a magnitude of vibratory motion. The example suspension 200 of the illustrated example gradually dissipates forces generated when the wheel (e.g., the wheel 102) traverses a bump, pothole, and or other road surface anomalies in a controlled manner that helps a driver maintain control over the vehicle 100 and/or provide the driver with a comfortable driving environment.

Additionally, the suspension 200 of the illustrated example measures a load applied to the suspension 200. For example, the shock absorber 202 of the illustrated example measures and/or detects a first load or force 212 applied in a direction between the first end 204 and the second end 208 (e.g., along a longitudinal axis) of the shock absorber 202. For example, the shock absorber 202 of the illustrated example receives the force 212 applied to the shock absorber 202 in a direction parallel to the longitudinal axis of the shock absorber 202. When the vehicle 100 receives a load, the shock absorber 202 of the illustrated example absorbs (e.g., damps) and/or dissipates forces and the associated energy to reduce discomfort of a driver of the vehicle 100.

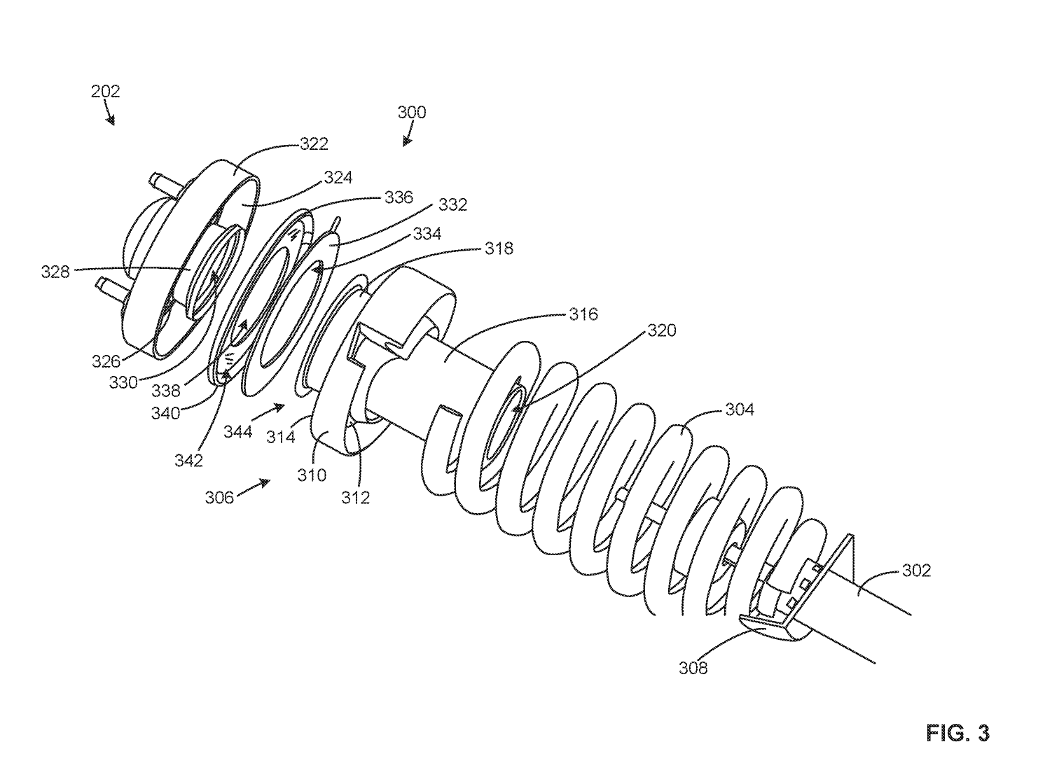

FIG. 3 is a partially exploded view of the example suspension 200 of FIG. 2. The shock absorber 202 of the illustrated example includes a housing 300 and a piston rod 302 movable relative to the housing 300. The illustrated example of FIG. 3 also includes means for biasing. In the illustrated example, the means for biasing is a spring 304. The spring 304 of the illustrated example is positioned between a first spring seat 306 formed adjacent an end of the housing 300 and a second spring seat 308 spaced from the first spring seat 306. The first spring seat 306 of the illustrated example includes a body 310 having a first surface 312 to engage or receive an end of the spring 304 and a second surface 314 opposite the first surface 312. The body 310 of the illustrated example includes a spring guide 316 (e.g., a first tube) protruding from the first surface 312 to guide the end of the spring 304 and a first boss 318 protruding from the second surface 314 to guide the piston rod 302. The body 310 of the illustrated example includes an opening 320 (e.g., a through hole) to slidably receive an end of the piston rod 302.

To cover or protect the piston rod 302 from damage and/or debris, the suspension 200 of the illustrated example includes a cap 322. The cap 322 of the illustrated example couples to the body 310 of the first spring seat 306. The cap 322 of the illustrated example includes an annular wall 324 (e.g., a circumferential wall) to define a cavity 326. The cap 322 of the illustrated example includes a second boss 328 positioned in the cavity 326 and having an opening 330 to receive the piston rod 302.

To measure a load (e.g. the force 212 of FIG. 2) applied to the vehicle 100, the suspension 200 of the illustrated example includes means for sensing a force. In the illustrated example, the means for sensing a force is a sensor (e.g., a force sensor) 332. The sensor 332 of the illustrated example is positioned on the second surface 314 of the first spring seat 306. The sensor 332 includes an opening 334 (e.g., a central hole) to receive the first boss 318 of the first spring seat 306. In some examples, the first boss 318 has a diameter that is substantially similar (e.g., slightly smaller than) a diameter of the opening 334 such that the first boss 318 prevents the sensor 332 from shifting or moving radially relative to a longitudinal axis of the shock absorber 202. Alternatively, in some examples, the sensor 332 may be printed onto the second surface 314 of the first spring seat 306 to reduce parts count.

To mitigate the sensor 332 from moving or displacing relative to the second surface 314, the suspension 200 of the illustrated example includes an isolator 336 (e.g., a rubber isolator). The isolator 336 includes an opening 338 (e.g., a central hole) to receive the piston rod 302 and an annular flange 340 defining a cavity 342 to receive the sensor 332. In some examples, the suspension 200 may not include the isolator 336.

To assemble the suspension 200, the sensor 332 is positioned on the second surface 314 of the first spring seat 306. The first boss 318 of the illustrated example may guide placement of the sensor 332 on the first spring seat 306. The isolator 336 is positioned on the sensor 332 and the cap 322 is coupled to the first spring seat 306. The cap 322 and the first spring seat 306 of the illustrated example define a cavity 344 to receive the isolator 336 and the sensor 332 when the cap 322 is coupled to the first spring seat 306. Additionally, the second boss 328 of the cap 322 of the illustrated example is adjacent (e.g., enjoins or couples to) the first boss 318 of the first spring seat 306 to provide a support or guide for the piston rod 302. The cap 322 and the first spring seat 306 of the illustrated example form or provide a tight seal to prevent debris or contaminates from entering the cavity 344 and/or the sensor 332. The sensor 332 of the illustrated example does not deflect to sense a load. Additionally, the isolator 336 and the sensor 332 of the illustrated example are relatively thin (e.g., 1 millimeter, 2 millimeters, 3 millimeters, etc.) so that a ride height of the vehicle 100 is not meaningfully altered (e.g., increased or decreased), and the components of the suspension 200 do not need to be modified. Thus, the sensor 332 provides a relatively low profile that does not require modification of the shock absorber 202 such that the example sensor 332 may be implemented with an existing shock absorber (e.g., an off-the-shelf shock absorber) and the sensor 332 will not meaningfully affect or vary (e.g., increase or decrease) a ride height of a vehicle.

During operation, a load provided to the wheel 102 imparts a load on the suspension 200. The sensor 332 of the illustrated example senses the load and produces (e.g., outputs) an electrical signal that corresponds to a magnitude of the load. The control system 110 (FIG. 1) may employ the output of the sensor 332 to adjust one or more parameters of the vehicle 100 to improve ride handling characteristics. In some examples, a user may employ the sensor 332 of the suspension 200 determine if a load carried by the vehicle 100 is too large. For example, a load provided or carried by the bed 112 (FIG. 1) of the vehicle 100 may be sensed by the sensor 332 of the suspension 200. The electrical signal may be sent to the control system 110 of the vehicle 100 to determine if the load is within an acceptable range, for example. If the load is not within an acceptable range, the control system 110 may provide an alert (e.g., a light on the dashboard, an audible noise, etc.) so the user of the vehicle 100 may address the issue. In some examples, the examples disclosed herein may be used to determine if a load is evenly distributed in the vehicle 100. For example, output signals from sensors (e.g., the sensor 332) positioned at each of the four wheels 102-108 (FIG. 1) may employed to determine if a load of the vehicle is (e.g., evenly) distributed. For example, if the output signals from sensors (e.g., the sensor 332) of the front wheels 102 and 104 are greater than a threshold, and output signals from sensors of the rear wheels 106 and 108 are less than a threshold, the control system 110 may warn the driver of the vehicle 100 to shift a load in the bed 112 of the vehicle 100 in FIG. 1 more towards a rear of the vehicle 100 so that the load is more evenly distributed.

To correlate outputs (e.g., electrical signals) of the sensor 332 to loads, the sensor 332 of the illustrated example is calibrated prior to installation on the suspension 200. For example, various known loads are applied to the sensor 332 (e.g., during a bench test). The resulting electrical signals produced by the sensor 332 are measured and a calibration curve is produced, indicating the correspondence between the applied load and the produced electrical signal. It is beneficial to calibrate the sensor 332 because some sensors are prone to calibration shift over time when the load distribution is not even (e.g., the resistive material migrates through the substrates to less-loaded areas). However, the disclosed configuration helps mitigate calibration shift because the sensor 332 is enclosed by the isolator 336, the first spring seat 306 and/or the first boss 318, which helps distribute the load and capture the entire load through the load path of the vehicle suspension 200.

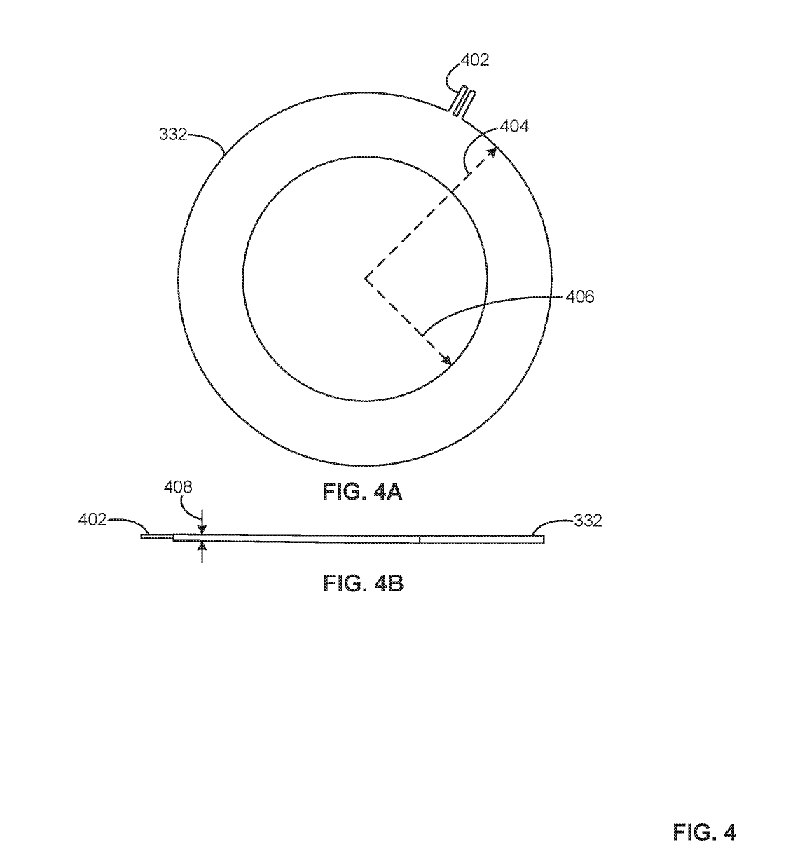

FIG. 4A is a top view of the example sensor 332 of FIG. 3. FIG. 4B is a side view of the example sensor 332 of FIGS. 3 and 4A. Referring to FIGS. 4A and 4B, the example sensor 332 includes leads 402 to communicatively couple the sensor 332 to the control system 110 of the vehicle 100. For example, the leads 402 may receive a voltage from the Engine Control Unit (ECU) to enable the sensor 332 to produce an electrical signal (e.g., a varying voltage) for sensing a load. In some examples, the leads 402 may receive a voltage and the sensor 332 may measure a change in resistance to detect an applied force. In the illustrated example, the sensor 332 is circular in shape. However, in some examples, the sensor 332 may have a square shape, a rectangular shape, and/or another shape. In the illustrated example of FIG. 4A, the sensor 332 has a first radius 404 and a second radius 406. The first radius 404 and the second radius 406 affect the output produced by the sensor 332 based on the material properties of the sensor 332. Additionally, the first radius 404 and the second radius 406 may be modified in any way so the sensor 332 may be positioned in and/or on a particular component or components of a suspension system. Also, to determine the expected output, the sensor 332 is provided a voltage and various known loads. The resulting outputs are correlated to the provided voltage and applied loads to produce a calibration curve.

The sensor 332 of the illustrated example may include one or more traces (e.g., electrical traces) to sense a force applied to the sensor 332. In some examples, the sensor 332 can detect a force without bending. In other words, the sensor 332 remains substantially flat (e.g., remains within 10% deflection from a plane of the thickness 408) when a force is applied to the sensor.

To manufacture the sensor 332 of the illustrated example, measurements are taken of the suspension component that is to house the sensor 332. For example, the sensor 332 is formed such that the first radius 404 and the second radius 406 are substantially similar (e.g., slightly smaller than) the second surface 314 of the first spring seat 306 and the diameter of the first boss 318. The sensor 332 of the illustrated example may be formed from Quantum Tunneling Composites, piezoelectric materials, piezo resistive materials, etc., that allow for the production of thin sensors. For example, the sensor 332 may be formed from a piezoelectric film pressed between two electrodes (e.g., copper) surrounded by a protective coating (e.g., polyethylene). In some examples, the sensor 332 may be a thin film transducer. In some examples, the sensor 332 may be printed onto the second surface 314 of the first spring seat 306 using, for example, heat molding manufacturing processes or techniques.

FIG. 4B illustrates a side view of the example sensor 332. The example sensor 332 may be manufactured to have a thickness 408 within a certain range. For example, the sensor 332 may have a thickness 408 of approximately between 1 millimeter and 6 millimeters. Manufacturing the sensor 332 to have a thickness within this range may improve results and/or will not meaningfully affect the ride height of the vehicle. In some examples, the sensor 332 may be manufactured to have a thickness outside of the above-noted range. For example, the sensor 332 may be manufactured to have a thickness less than 1 millimeter.

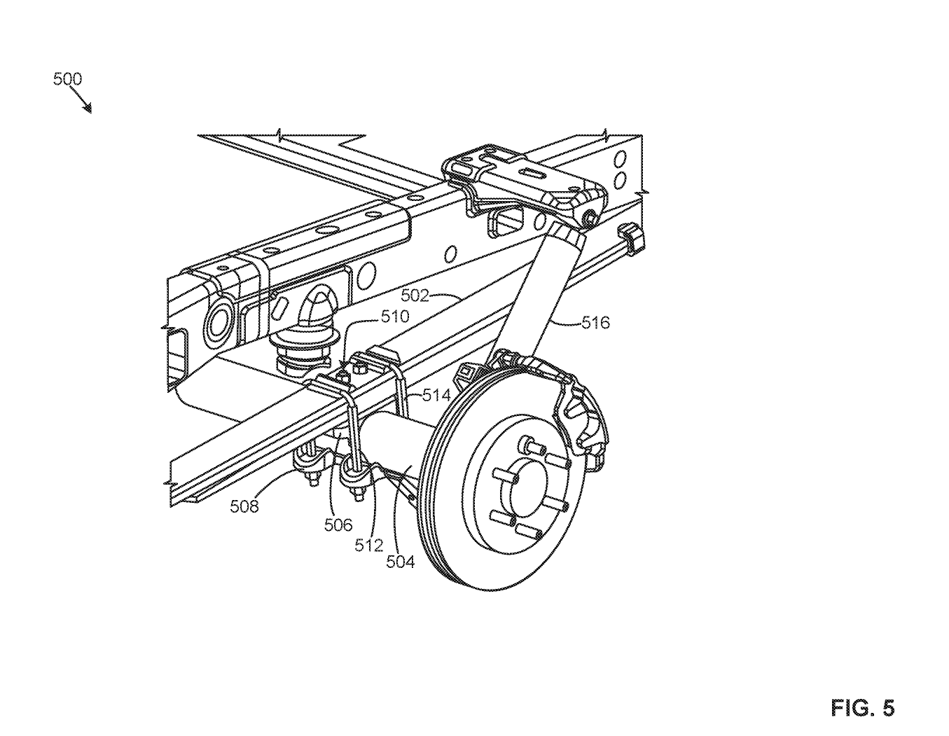

FIG. 5 illustrates another example suspension 500 that may be used to implement the example vehicle 100 of FIG. 1. For example, the suspension 500 of the illustrated example may support the rear wheels 106 and 108 of the vehicle 100 of FIG. 1. The example suspension 500 of the illustrated example is an example leaf-spring suspension. The suspension 500 of the illustrated example includes means for biasing. In the illustrated example, the means for biasing is a biasing element 502. The biasing element 502 is coupled to an axle 504 of the vehicle 100. In the illustrated example, the biasing element 502 is a leaf spring that extends perpendicular relative to the axle 504 of the vehicle 100. The axle 504 of the illustrated example includes a spring seat 506 to receive the biasing element 502 and a bracket 508 and U-bolts 512, 514 to couple the biasing element 502 to the axle 504.

During operation, the biasing element 502 deflects in response to forces generated when the wheels 106, 108 (FIG. 1) traverse a bump, pothole, and/or other road surface anomaly. In the illustrated example, a shock absorber 516 absorbs (e.g., damps) and/or dissipates forces and the associated energy in a controlled manner to mitigate driver discomfort. Additionally, the suspension 500 of the illustrated example measures a load applied to the suspension 500. For example, the biasing element 502 of the illustrated example measures and/or detects a first load or force 510 applied at a deflection point of the biasing element 502.

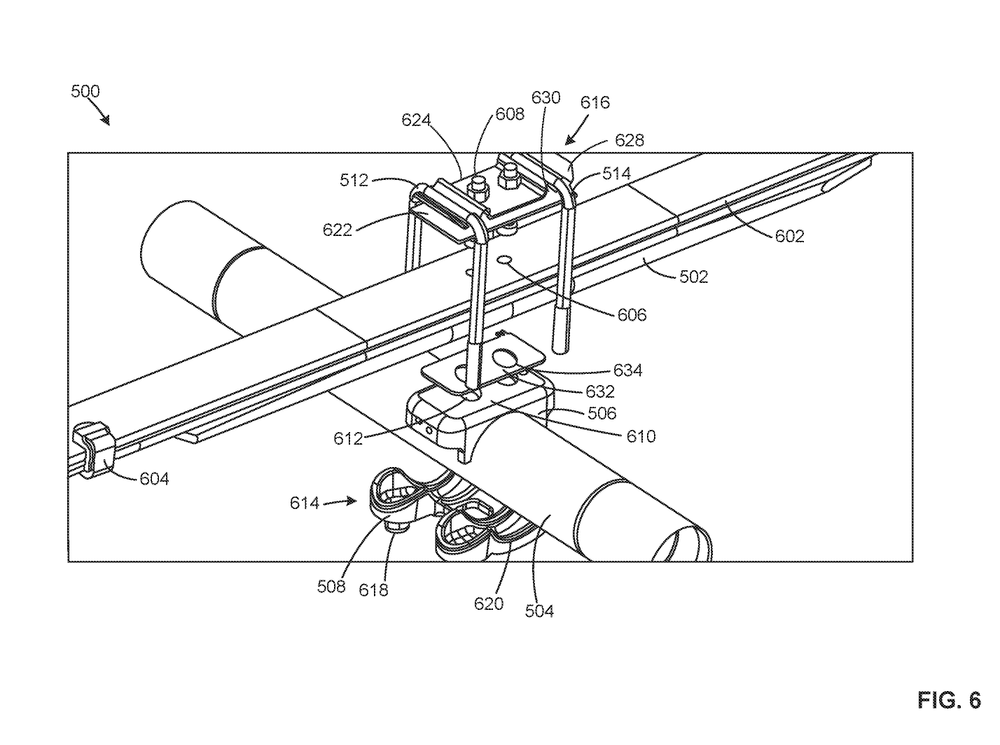

FIG. 6 is a partially exploded view of the example suspension 500 of FIG. 5 including the biasing element 502, the axle 504, the spring seat 506, and the bracket 508. The biasing element 502 of the illustrated example includes leaves 602 (e.g., metal strips) coupled to one another. In the illustrated example, the leaves 602 are coupled by a clip 604 (e.g., a rebound clip) that prevents the leaves 602 from fanning out. In the illustrated example, the leaves 602 include openings 606 (e.g., through holes) to receive fasteners 608 to couple the leaves 602 to one another. The spring seat 506 of the illustrated example includes a first surface 610 to support or engage the biasing element 502.

To couple the biasing element 502 to the spring seat 506, the suspension 500 includes the bracket 508. The bracket 508 of the illustrated example includes a first portion 614 and a second portion 616 removably coupled to the first portion 614. The first portion 614 of the illustrated example includes apertures 618 to receive the second portion 616. In the illustrated example, the first portion 614 includes a recessed area 620 to engage the axle 504. The second portion 616 of the illustrated example includes the fasteners 608 and a plate 622. The plate 622 of the illustrated example includes a top bracket 624 to couple the U-bolts 512, 514 to the plate 622. The top bracket 624 of the illustrated example includes a tongue 628 and a recess 630 to receive the U-bolt 514. For example, to receive the U-bolt 514, the tongue 628 is elevated and the U-bolt 514 is placed in the recess 630. The tongue 628 is lowered to secure the U-bolt 514 in the recess 630.

To measure a load applied to the vehicle 100, the suspension 500 of the illustrated example includes a sensor (e.g., a force sensor) 632. The sensor 632 of the illustrated example is positioned on the first surface 610 of the spring seat 506. In the illustrated example, the sensor 632 includes openings 634 to receive the fasteners 608 to enable the fasteners 608 to engage or couple to the spring seat 506. In some examples, the sensor 632 does not include the openings 634 when the fasteners 608 do not engage or couple to the spring seat 506. Alternatively, in some examples, the sensor 632 may be printed onto the first surface 610 of the spring seat 506 to reduce parts count.

To assemble the suspension 500, the sensor 632 is positioned on the first surface 610 of the spring seat 506. The biasing element 502 is positioned on the sensor 632 and the bracket 508 couples the biasing element 502 to the spring seat 506. In the illustrated example, the sensor 632 is thin (e.g., 1 millimeter, 2 millimeters, 3 millimeters, etc.) so that the ride height of the vehicle 100 is not meaningfully changed, and the components of the suspension 500 do not need to be modified in any way. The sensor 632 functions or operates substantially similar to the sensor 332 of the example suspension 200 of FIGS. 2-3, 4A and 4B.

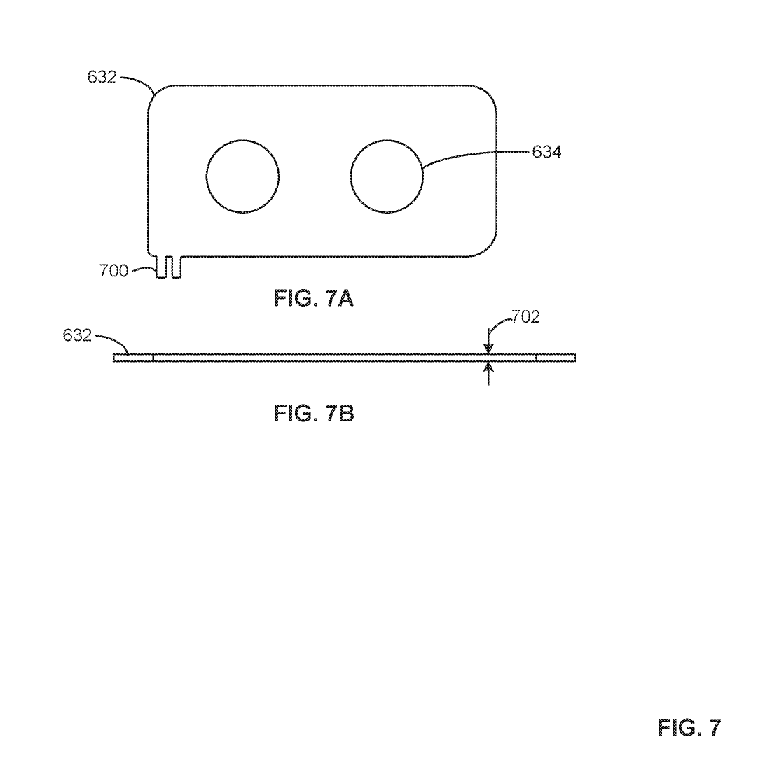

FIG. 7A is a top view of the example sensor 632 of FIG. 6. FIG. 7B is a side view of the example sensor 632 of FIGS. 6 and 7A. Referring to FIGS. 7A and 7B, the example sensor 632 of the illustrated example includes leads 700 to communicatively couple the sensor 632 to the control system 110 of the vehicle 100. For example, the leads 700 may receive a voltage from the ECU to enable the sensor 632 to produce an electrical signal (e.g., a varying voltage) for determining a detected load. In some examples, the leads 700 may receive a voltage and the sensor 632 may measure a change in resistance to detect an applied force. In the illustrated example, the sensor 632 is rectangular in shape. However, in some examples, the sensor 632 may have a square shape, a circular shape, and/or another shape. In the illustrated example, the sensor 632 includes the openings 634 to receive the fasteners 608. The openings 634 of the illustrated example may be sized to fit any suspension component. In some examples, the sensor 632 may not include the openings 634. In some examples, the sensor 632 may be the sensor 332 of FIGS. 2-3, 4A and 4B.

FIG. 7B illustrates a side view of the example sensor 632. The example sensor 632 may be manufactured to have a thickness 702 within a certain range. For example, the sensor 632 of the illustrated example may have a thickness 702 approximately between 1 millimeter and 6 millimeters. Manufacturing the sensor 632 to have a thickness within this range may improve results and/or does not meaningfully affect the ride height of the vehicle. In some examples, the sensor 632 may be manufactured to have a thickness outside of the above-noted range. For example, the sensor 632 may be manufactured to have a thickness less than 1 millimeter.

To manufacture the sensor 632 of the illustrated example, measurements are taken of the suspension component that will house the sensor 632. For example, the example sensor 632 is formed to be substantially similar (e.g., slightly smaller than) the first surface 610 of the spring seat 506. The sensor 632 of the illustrated example may be formed from Quantum Tunneling Composites, piezoelectric materials, piezo resistive materials, etc., that allow for the production of thin sensors. For example, the example sensor 632 may be formed from a piezoelectric film pressed between two electrodes (e.g., copper) surrounded by a protective coating (e.g., polyethylene). In some examples, the example sensor 632 may be printed onto the first surface 610 of the spring seat 506 using, for example, heat molding manufacturing processes or techniques.

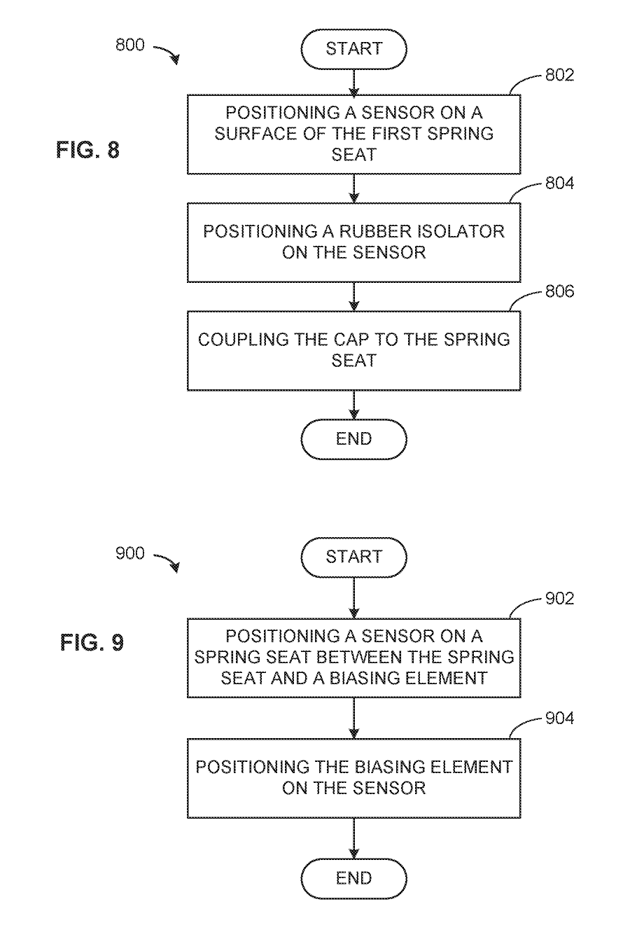

FIG. 8 is an example method 800 of assembling the example vehicle suspension 200 of FIGS. 2 and 3. FIG. 9 is an example method 900 of assembling the example vehicle suspension 500 of FIGS. 5 and 6. While an example manner of assembling the suspensions 200 and 500 are illustrated in FIGS. 8 and 9, one or more of the steps and/or processes illustrated in FIGS. 8 and 9 may be combined, divided, re-arranged, omitted, eliminated and/or implemented in any other way. Further still, the example methods of FIGS. 8 and 9 may include one or more processes and/or steps in addition to, or instead of, those illustrated in FIGS. 8 and 9, and/or may include more than one of any or all of the illustrated processes and/or steps. Further, although the example methods are described with reference to the flowcharts illustrated in FIGS. 8 and 9, many other methods of assembling the suspensions 200 and 500 of FIGS. 2-3 and 5-6 may alternatively be used.

The example method 800 begins when the sensor 332 is positioned on a surface of the first spring seat 306 (block 802). For example, positioning the sensor 332 on the surface 314 of the first spring seat 306. The isolator 336 is positioned on the sensor 332 (block 804). The cap 322 is then coupled to the spring seat 306 (block 806).

Referring to FIG. 9, the sensor 632 is positioned on the spring seat 506 between the spring seat 506 (block 902). The biasing element 502 is positioned (e.g., directly) on the sensor 632 (block 904). For example, the sensor 632 is positioned between the spring seat 506 and the biasing element 502. The bracket 508 couples the biasing element 502, the spring seat 506 and the sensor 632 to the axle 504.

From the foregoing, it will be appreciated that example methods, apparatus and articles of manufacture have been disclosed that enable an efficient, low-profile solution to measure vehicle weight across multiple platforms without the need to design for multiple suspension architectures. The examples disclosed are beneficial because these examples utilize thin sensors that can be implemented with (e.g., installed in) existing suspensions requiring minimal change to manufacturing and assembly of the suspensions. Additionally, the sensors disclosed herein are relatively thin and may increase a ride height by less than one millimeter. The examples disclosed are capable of being used across multiple platforms of the vehicle other than suspensions. For example, under a bed of a vehicle. The disclosed examples increase resistance to environmental factors (e.g., temperature, humidity, shock) and these examples are cost and weight efficient. In addition, the disclosed examples improve electronic stability control, accuracy in driveline calibration, algorithms based on vehicle weight distribution, autonomous vehicle systems, and information provided to driver to reduce unbalanced driving.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a vehicle spring positioned between a first spring seat and a second spring seat;
a cap coupled to the first spring seat to define a cavity; and
a force sensor positioned in the cavity adjacent a surface of the first spring seat.

2. The apparatus of claim 1, further including an isolator to engage the force sensor when the surface of the first spring seat is positioned in the cavity.

3. The apparatus of claim 1, wherein the force sensor is a thin film transducer.

4. The apparatus of claim 2, wherein the isolator is flat, having a circumferential wall to receive the force sensor.

5. The apparatus of claim 1, wherein the force sensor is to detect a force applied to the spring seat.

6. The apparatus of claim 5, wherein the force sensor is to receive a voltage and measure a change in resistance to detect the force applied to the first spring seat.

7. The apparatus of claim 1, wherein the force sensor is printed onto the surface of the spring seat.

8. The apparatus of claim 1, wherein the force sensor has a circular shape.

9. The apparatus of claim 1, wherein the force sensor remains substantially flat when a force is applied to the sensor.

10. The apparatus of claim 1, wherein the force sensor has a dimensional thickness that is less than 5 millimeters.

11. An apparatus comprising:
a spring seat;
means for biasing; and
a force sensor positioned between the spring seat and the means for biasing.

12. The apparatus of claim 11, wherein the force sensor has a rectangular shape.

13. The apparatus of claim 11, wherein the force sensor is to detect a force applied to the means for biasing.

14. The apparatus of claim 11, wherein the means for biasing is a leaf spring.

15. The apparatus of claim 11, wherein the spring seat defines a cavity, and the force sensor is positioned in the cavity.

16. An apparatus comprising:
means for biasing positioned between a first spring seat and a second spring seat;
a cap coupled to the first spring seat to define a cavity;
an isolator positioned in the cavity; and
means for sensing a force positioned in the cavity adjacent a surface of the first spring seat.

17. The apparatus of claim 16, wherein the isolator is flat, having a circumferential wall to receive the means for sensing a force.

18. The apparatus of claim 16, wherein the means for sensing a force is to detect a force applied to the spring seat.

19. The apparatus of claim 18, wherein the means for sensing a force is to receive a voltage and measure a change in resistance to detect the force applied to the first spring seat.

20. The apparatus of claim 16, wherein the means for sensing a force remains substantially flat when a force is applied to the means for sensing a force.
